(19) United States
(12) Patent Application Publication
(10) Pub. No.: US 2026/0227028 A1
(43) Pub. Date: Aug. 6, 2026

(54) MONITOR STAND SYSTEM WITH LIFTABLE AND ROTATABLE PLATFORM

(71) Applicant: Peter Kao, Industry, CA (US)

(72) Inventor: Peter Kao, Industry, CA (US)

(21) Appl. No.: 19/047,511

(22) Filed: Feb. 6, 2025

(51) Int. Cl. F16M 11/38; F16M 11/20

(52) U.S. Cl. CPC F16M 11/38; F16M 11/2014

(57) ABSTRACT

A monitor stand system includes a bottom case, a lift case, a controller, a height adjustment mechanism, and a rotating mechanism. The lift case is located on and movably coupled to the bottom. The height adjustment mechanism is connected to both the bottom case and the lift case. The height adjustment mechanism can raise and lower the lift case to dynamically adjust the height and angle of a monitor for ergonomic comfort. The rotating mechanism can adjust the viewing angle of the monitor to promote eye health and reduce fatigue during prolonged screen use.

### FIELD OF THE INVENTION

The present invention generally relates to monitor stands, more particularly, to a monitor stand system capable of lifting and rotating a monitor.

### BACKGROUND OF THE INVENTION

In the modern digital age, prolonged computer usage has become commonplace in both professional and personal settings. This has led to increased concerns about ergonomics and the health implications of extended screen time. Conventional monitor stands often lack adjustable features that cater to individual user needs, such as varying heights and viewing angles. While some adjustable monitor stands exist, they typically require manual adjustments, which can be inconvenient and disrupt workflow.

Moreover, conventional monitor stands are usually configured to adjust to a specific setting before the user begins using the monitor. They lack the capability to make adaptive adjustments in response to the user's real-time needs.

### SUMMARY OF THE INVENTION

In order to overcome the disadvantages associated with the aforementioned monitor stand, a monitor stand system with a liftable platform is disclosed. The monitor stand system may include a bottom case, a lift case, a controller, and a height adjustment mechanism. The lift case is located on and movably coupled to the bottom case. The controller is configured to generate a height adjustment signal. The height adjustment mechanism is connected to the bottom case and the lift case, and it is electrically coupled to the controller. The height adjustment mechanism includes an arm assembly. The height adjustment mechanism is configured to raise and lower the lift case to various heights according to the height adjustment signal.

The monitor stand system may be configured such that the work platform is located on and rotatably connected to the lift case. The rotating platform is located beneath and connected to the lift case, and it is electrically coupled to the controller. The rotating mechanism includes a shaft extending through the lift case and connected to the work platform. The rotating mechanism is configured to rotate the work platform relative to the lift case at various angles according to an angle adjustment signal generated by the controller.

The monitor stand system may be configured such that the rotating mechanism further includes a top turntable and a bottom turntable. The top turntable is attached to the work platform and the shaft of the rotating mechanism. The bottom turntable is opposite to the top turntable and attached to the lift case.

The monitor stand system may be configured such that the rotating mechanism further includes a worm gear mechanism and a first motor. The worm gear mechanism is coupled to the shaft. The first motor is coupled to the worm gear mechanism.

The monitor stand system may further include a connecting platform. The connecting platform is located between the height adjustment mechanism and the lift case. The connecting platform has a recessed structure in its center. The shaft of the rotating mechanism is located within and extends through the recessed structure.

The monitor stand system may be configured such that the rotating mechanism is located beneath the recessed structure of the connecting platform.

The monitor stand system may be configured such that the height adjustment mechanism may include two height adjustment mechanisms. The two height adjustment mechanisms are located on opposite sides of the recessed structure and beneath the connecting platform.

The monitor stand system may be configured such that the arm assembly of the height adjustment mechanism may include two sets of arms that connect at scissoring pivot points. The arm assembly may create a scissoring motion when raising and lowering the lift case.

The monitor stand system may be configured such that the height adjustment mechanism may further include base pivot points, lift pivot points, sliding assemblies and a second motor. The base pivot points are coupled to the bottom case, and each one is fixed relative to the bottom case. The lift pivot points are coupled to the lift case, and each one is fixed relative to the lift case. The sliding assemblies are located on an end of an arm of the two sets of arms between the end of the arm and either the lift case or the bottom case. The second motor has a driving shaft. The driving shaft is coupled to the arm assembly. The second motor is configured to provide a force that drives the scissoring motion.

The monitor stand system may be configured such that the base pivot and lift pivot points are located on the same side of the scissoring pivot points.

The monitor stand system may be configured such that the lift case may further include an optical sensor. The optical sensor is electrically coupled to the controller. The optical sensor is configured to detect and store an initial position of user's eyes as a reference. The controller is further configured to control the height adjustment mechanism to raise or lower the lift case based on a deviation between a real-time position of the user's eyes and the reference.

The monitor stand system may be configured such that the controller is further configured to control the rotating mechanism to rotate the work platform based on a deviation between a real-time position of the user's eyes and the reference.

The monitor stand system may be configured such that the optical sensor is configured to detect a user in front of the lift case. The controller is further configured to deactivate a rotation movement and a lifting movement of the work platform in the absence of the user, and to automatically activate the rotation movement and the lifting movement upon detecting the user.

The monitor stand system may be configured such that the controller is configured to rotate the work platform clockwise and counterclockwise twice over a short distance when the optical sensor detects that the user has been in front of the lift case for longer than a set duration to remind the user to take a break.

One embodiment of the present disclosure may provide a monitor stand with a rotatable platform. The monitor stand system may include a bottom case, a lift case, a controller, a work platform, and a rotating mechanism. The lift case is located on and movably coupled to the bottom case. The controller is configured to generate an angle adjustment signal. The work platform is located on and rotatably connected to the lift case. The rotating platform is located beneath and connected to the lift case, and it is electrically coupled to the controller. The rotating mechanism includes a shaft extending through the lift case and connected to the work platform. The rotating mechanism is configured to rotate the work platform relative to the lift case at various angles according to the angle adjustment signal.

The monitor stand system may be configured such that the monitor stand system may be configured such that the rotating mechanism further includes a worm gear mechanism and a first motor. The worm gear mechanism is coupled to the shaft. The first motor is coupled to the worm gear mechanism.

### BRIEF DESCRIPTION OF THE DRAWINGS

The drawings illustrate examples. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 shows a perspective view of an embodiment of a monitor stand system.

FIG. 2 shows an exploded perspective view of the monitor stand system shown in FIG. 1.

FIG. 3 shows a perspective view of an embodiment of the height adjustment mechanism of the monitor stand system in a lifted position.

FIG. 4 shows a perspective view of an embodiment of the height adjustment mechanism of the monitor stand system in the stowed position.

FIG. 5 shows a side view of the monitor stand system in operation by a user, with the lift case in a stowed position.

FIG. 6 shows a perspective view of the monitor stand system in operation by a user, with the lift case in a lifted position.

FIG. 7 shows a perspective view of the rotating mechanism of the monitor stand system shown in FIG. 1.

FIG. 8 shows a perspective view of the monitor stand system shown in FIG. 1, where the work platform rotates in a clockwise direction.

FIG. 9 shows a perspective view of the monitor stand system shown in FIG. 1, where the work platform rotates in a counterclockwise direction.

### DETAILED DESCRIPTION OF THE PREFERRED EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

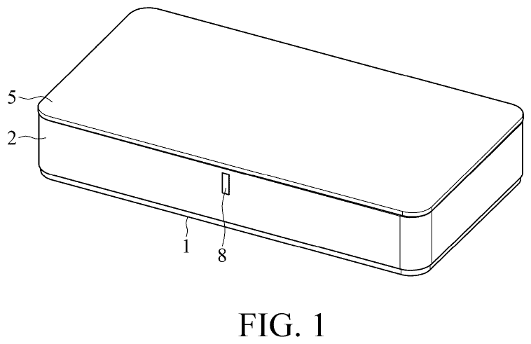

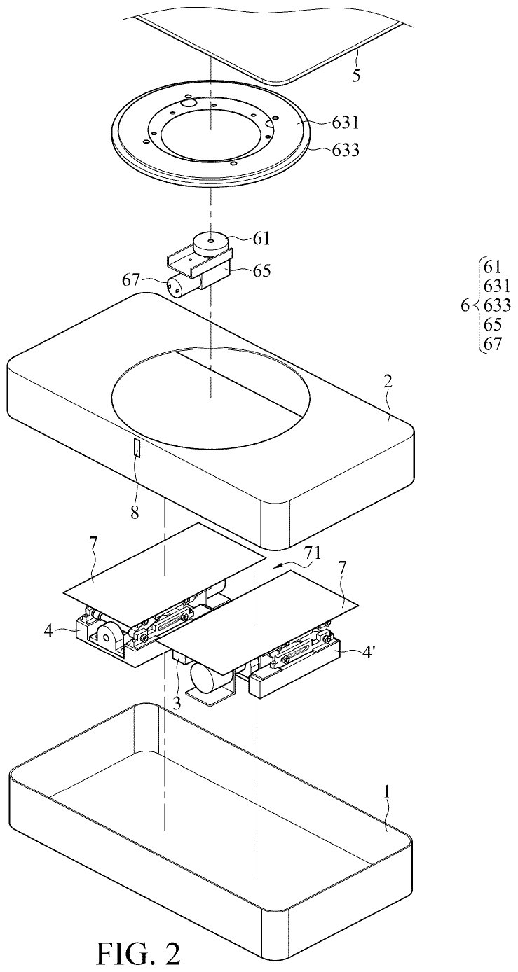

FIG. 1 shows a perspective view of an embodiment of a monitor stand system. FIG. 2 shows an exploded perspective view of the monitor stand system shown in FIG. 1. Referring to FIGS. 1 and 2, in this embodiment, the monitor stand system includes a bottom case 1, a lift case 2, a controller 3, and a height adjustment mechanism 4.

The controller 3 can generate a set of signals, such as a height adjustment signal. These signals can be received and stored in a memory unit electrically coupled to the controller 3. This allows the user to input operation requests corresponding to the signals in advance. In some embodiment, the controller 3 can be implemented by one or more of a microprocessor, a microcontroller, a digital signal processor, a microcomputer, a central processing unit, a field programmable gate array, a programmable logic device, a logic circuit, an analog circuit, a digital circuit, and/or any processing element that operates signals based on operation instructions.

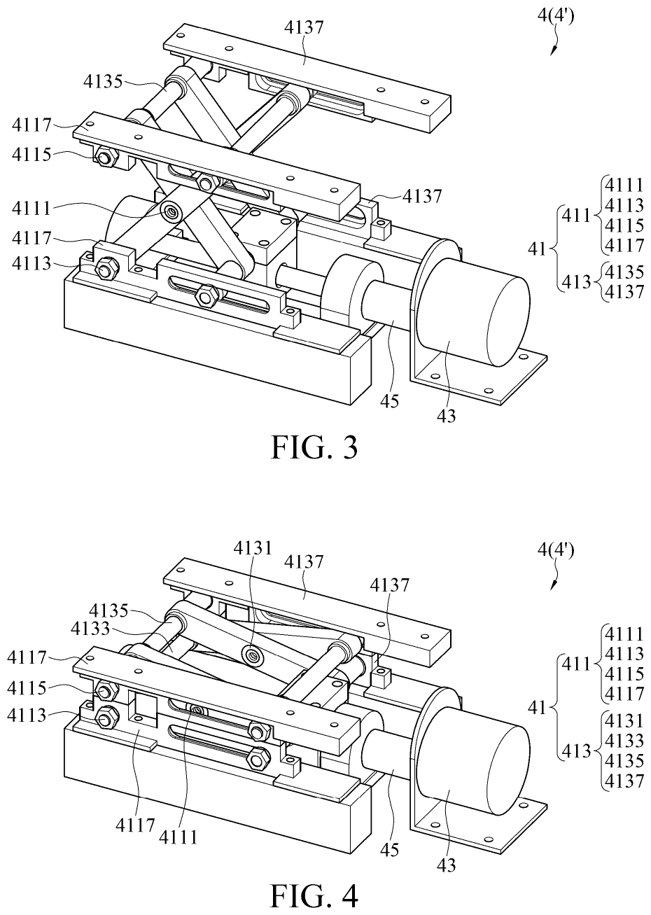

Referring to FIGS. 3 and 4, in this embodiment, the height adjustment mechanism 4 is connected to the bottom case 1 and the lift case 2, and it is electrically coupled to the controller 3. The height adjustment mechanism 4 includes an arm assembly 41. Consequently, the controller 3 can adjust the height adjustment mechanism 4 to a lifted position, as shown in FIG. 3, or a lowered position, as shown in FIG. 4.

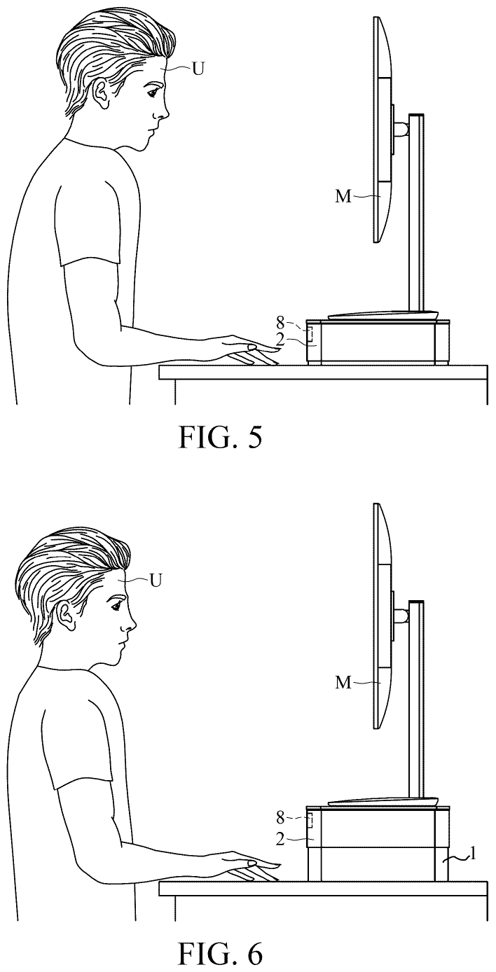

FIG. 5 shows a side view of the monitor stand system in operation by a user U, with the lift case 2 in a stowed position, as indicated in FIG. 4. FIG. 6 shows a perspective view of the monitor stand system in operation by a user U, with the lift case in a lifted position, as indicated in FIG. 3. In this embodiment, the height adjustment mechanism 4 can raise and lower the lift case 2 to various heights according to the height adjustment signal from the controller 3. By raising the lift case 2 to a suitable lifted position, the monitor M can be elevated to a comfortable viewing height. This allows the user U to work efficiently in front of the monitor M.

As such, the monitor stand system effectively promotes eye health and comfort by dynamically adjusting the monitor's height relative to the user's eyes. By allowing the monitor to be positioned at a preferred height adaptively set for the user, the system optimizes the user's posture and viewing angle.

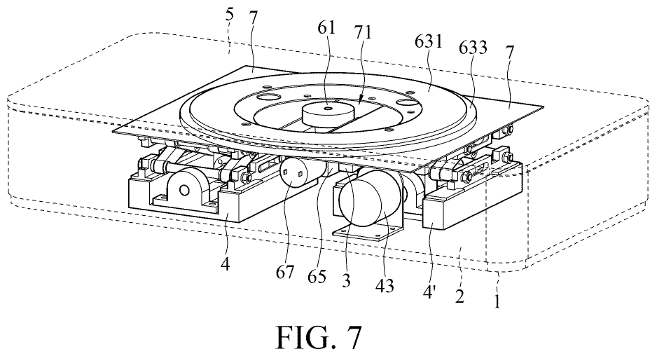

In another embodiment of the present disclosure, referring to FIGS. 2 and 7, a monitor stand system includes a bottom case 1, a lift case 2, a controller 3, a height adjustment mechanism 4, a work platform 5, and a rotating mechanism 6. The technical features, advantages and embodiments related to the bottom case 1, lift case 2, controller 3, and height adjustment mechanism 4 are similar to or the same as those described above and are therefore omitted here to avoid redundancy.

In this embodiment, the controller 3 can further generate an angle adjustment signal. The work platform 5 is located on and rotatably connected to the lift case 2. The rotating platform 6 is located beneath and connected to the lift case 2. The rotating platform 6 is electrically coupled to the controller 3. The rotating mechanism 6 includes a shaft 61 extending through the lift case 2 and connected to the work platform 5.

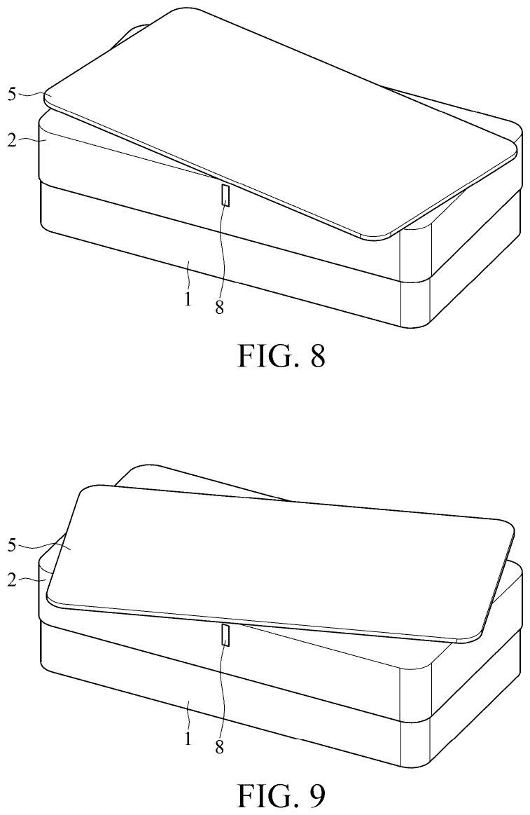

FIGS. 8 and 9 illustrate perspective views of the monitor stand system during operation. FIG. 8 shows the work platform 5 rotating in a clockwise direction, while FIG. 9 shows the work platform 5 rotating in a counterclockwise direction. In this embodiment, the rotating mechanism 6 can rotate the work platform 5 relative to the lift case 2 at various angles according to the angle adjustment signal from the controller 3.

As such, the monitor stand system effectively promotes eye health and comfort by dynamically adjusting the monitor's angle and height relative to the user's eyes. By enabling the work platform to rotate clockwise and counterclockwise at predefined angles after reaching a preferred height adaptively set for the user, the system facilitates regular changes in the user's viewing angle from the monitor on the work platform. This adjustment prompts the eyes to frequently shift focus, engaging the lens and suspensory ligaments and preventing them from remaining in a fixed, tense state for extended periods.

In some embodiments, the signals further include a set time and a set angle. The rotating mechanism 6 can receive the set time signal from the controller 3. Thus, it can rotate the work platform 5 relative to the lift case 2 in either the clockwise or counterclockwise direction, based on the set angle and set time. By enabling the work platform 5 to rotate clockwise and counterclockwise at predefined angles and time intervals, the system facilitates regular changes in the user's viewing angle from the monitor on the work platform 5. Consequently, the system helps alleviate common symptoms of prolonged screen use, such as eye fatigue, dry eyes, and blurred vision, and may reduce the risk of long-term vision issues, supporting a more ergonomic and user-friendly experience.

In one embodiment, the set time is, but is not limited to, intervals of 15 minutes. This enables the work platform 5 to rotate clockwise and counterclockwise at the set time interval. Additionally, in some embodiments, the set angles may be defined as separate clockwise and counterclockwise angles. For instance, the clockwise angle is 30 degrees, while the counterclockwise distance is 20 degrees, although other distances may also be used.

In one embodiment, referring again to FIGS. 2 and 7, in one embodiment, the monitor stand system further includes a connecting platform 7. The connecting platform 7 is located between the height adjustment mechanism 4 and the lift case 2. The connecting platform 7 has a recessed structure 71 in its center. The shaft 61 of the rotating mechanism 6 is located within and extends through the recessed structure 71. This layout ensures that the shaft 61 is securely positioned and aligns the rotating mechanism 6 with the lift case 2, enabling smooth rotation of the work platform 5 without interfering with the height adjustment process, thereby enhancing stability and operational reliability.

In one embodiment, the rotating mechanism 6 further includes a top turntable 631 and a bottom turntable 633. The top turntable 631 is attached to both the work platform 5 and the shaft 61 of the rotating mechanism 6. The bottom turntable 633 is positioned opposite the top turntable 631 and is attached to the underside of the lift case 2. Preferably, the rotating mechanism 6 also includes a plurality of ball bearings (not shown) disposed between the top and bottom turntables 631, 633. This arrangement minimizes friction between the turntables 631, 633, enabling smooth and precise rotation of the work platform 5. Additionally, the use of ball bearings reduces wear and tear, increasing the durability and efficiency of the rotating mechanism 6.

In one embodiment, the rotating mechanism 6 includes a worm gear mechanism 65 and a first motor 67. The worm gear mechanism 65 is coupled to the shaft 61, and the first motor 67 is coupled to the worm gear mechanism 65. Preferably, the worm gear mechanism 65 and the first motor 67 of the rotating mechanism 6 are fixed relative to and located beneath the recessed structure 71 of the connecting platform 7. Because the rotating mechanism 6 is secured to the lift case 2 via the connecting platform 7, when the lift case 2 rises, the entire rotating mechanism 6 rises with it. Consequently, regardless of the height to which the lift case 2 is elevated, the work platform 5 remains independently capable of rotation. This configuration provides seamless adaptability, ensuring that the platform's rotary functionality is maintained at all heights, improving ergonomic flexibility and operator comfort while maintaining consistent rotary performance.

In one embodiment, referring to FIGS. 2-4, 3, the height adjustment mechanism 4 includes two height adjustment mechanisms 4′, 4″, positioned on opposite sides of the recessed structure 71 and located beneath the connecting platform 7. Each height adjustment mechanism 4′, 4″ operates synchronously to provide a balanced and stable lifting motion for the lift case 2. This configuration ensures even weight distribution and eliminates tilting during height adjustments, thereby improving the structural stability and operational precision of the monitor stand system.

Referring to FIGS. 3 and 4, the arm assembly 41 of the height adjustment mechanism 4 includes two sets of arms 411, 413. Each set consists of two arms connected at scissoring pivot points 4111, 4131, which enable the arms 411, 413 to perform a scissoring motion during the raising and lowering of the lift case 2. The scissoring motion facilitates smooth and controlled vertical movement, reducing mechanical strain on the system. This design enables efficient height adjustment while maintaining durability and minimizing wear on moving components.

Referring to FIG. 4 again, the height adjustment mechanism 4 also includes base pivot points 4113, 4133, lift pivot points 4115, 4135, and sliding assemblies 4117, 4137. The base pivot points 4113, 4133 are coupled to the bottom case 1 and are fixed relative to the bottom case 1. The lift pivot points 4115, 4135 are coupled to the lift case 2 and are fixed relative to the lift case 2. The sliding assemblies 4117, 4137 are located at the ends of the arms 411, 413 and interface with either the lift case 2 or the bottom case 1. These sliding assemblies enable the arms to maintain smooth linear movement along the corresponding cases during operation. This arrangement ensures consistent and precise motion while accommodating the vertical displacement of the lift case 2.

Preferably, the height adjustment mechanism 4 is driven by a second motor 43. The second motor 43 includes a driving shaft 45 coupled to the arm assembly 41. The second motor 43 provides the necessary force to drive the scissoring motion of the arms 411, 413, allowing the lift case 2 to move upward or downward efficiently. This motorized operation reduces the manual effort required by the user, enhances the speed of height adjustment, and provides a smooth and reliable lifting experience.

In one embodiment, the base pivot points 4113, 4133 and the lift pivot points 4115, 4135 are located on the same side of the scissoring pivot points 4111, 4131. This configuration allows the scissoring arms to operate more compactly, reducing the overall footprint of the height adjustment mechanism 4 within the monitor stand system. By aligning the pivot points on the same side, the arm assembly achieves greater mechanical efficiency, enabling smoother transitions during lifting and lowering operations. This design minimizes unnecessary lateral motion, optimizes the use of available space, and enhances the stability of the lift case 2 during height adjustments.

Referring again to FIGS. 1 and 5, in one embodiment, the lift case 2 includes an optical sensor 8. The optical sensor 8 is electrically coupled to the controller 3. The optical sensor 8 can detect and store an initial position of user's eyes as a reference. For instance, the optical sensor 8 is a facial recognition camera. The controller 3 can compare the detected real-time position of the user's eyes with the reference stored in its memory, and then the controller 3 can activate the height adjustment mechanism 4 to raise or lower the lift case 2 if the real-time position deviates from the reference. This configuration ensures that the monitor's height is continuously optimized for the user's posture, reducing strain on the neck and eyes and improving ergonomic comfort during extended use.

Referring to FIGS. 7-9, in another embodiment, the user initially stands directly in front of the monitor stand system and then steps aside laterally. Simultaneously, the controller 3 compares the detected real-time position of the user's eyes with the reference stored in its memory. If a deviation between the real-time position and the reference is detected, the controller 3 can activate the rotating mechanism 6 to rotate the work platform 5 either clockwise or counterclockwise. The rotation realigns the monitor with the user's optimal viewing angle and minimizes strain caused by misalignment. For instance, if the user shifts their position laterally while working, the rotating mechanism 6 dynamically adjusts the monitor's orientation to maintain the user's line of sight within the ideal ergonomic range. This configuration allows the monitor to continuously track and adapt to the user's movements, promoting a comfortable and optimized viewing experience.

In another embodiment, the optical sensor 8 can detect whether a user is present in front of the lift case 2. For instance, the optical sensor 8 is an infrared optical sensor. If no user is detected, the controller 3 deactivates the rotation movement and the lifting movement of the work platform 5 to conserve energy and prevent unnecessary operation. Upon detecting the presence of a user, the controller 3 automatically reactivates the rotation movement and the lifting movement of the work platform 5. This design enhances energy efficiency and extends the lifespan of the rotating mechanism 6 by operating only when necessary, while also providing a responsive user experience.

Preferably, if the optical sensor 8 detects that the user has been in front of the lift case 2 for longer than a set duration, such as 50 minutes, the controller 3 can rotate the work platform 5 clockwise and counterclockwise twice over a short distance as a reminder for the user to take a break. This feature promotes healthier habits by encouraging users to take regular breaks, reducing the risk of discomfort or fatigue caused by prolonged computer use.

Accordingly, the monitor stand system can offer a solution to the limitations of conventional monitor stands by providing automatic adjustments that enhance ergonomics and productivity. By adapting to the user's presence and habits, the system promotes a healthier working environment. In addition, the system is suitable for various settings, including offices, homes, and public spaces where monitors are used. It can accommodate different monitor sizes and weights, making it versatile for a wide range of applications.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

The terms and expressions used herein have the ordinary meaning accorded to such terms and expressions in their respective areas, except where specific meanings have been set forth. Relational terms such as “clockwise” and “counterclockwise” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by “a” or “an” does not, without further constraints, preclude the existence of additional elements of the identical type.

What is claimed is:

1. A monitor stand system comprising:
a bottom case;
a lift case located on and movably coupled to the bottom case;
a controller configured to generate a height adjustment signal; and
a height adjustment mechanism connected to both the bottom case and the lift case and electronically coupled to the controller, the height adjustment mechanism comprising an arm assembly, configured to raise and lower the lift case to various heights according to the height adjustment signal.

2. The monitor stand system of claim 1, wherein the rotating mechanism further comprises:
a work platform located on and rotatably connected to the lift case; and
a rotating mechanism located beneath and connected to the lift case and electronically coupled to the controller, the rotating mechanism comprising a shaft extending through the lift case and connected to the work platform, configured to rotate the work platform relative to the lift case at various angles according to an angle adjustment signal generated by the controller.

3. The monitor stand system of claim 2, wherein the rotating mechanism further comprises:
a top turntable attached to the work platform and the shaft of the rotating mechanism; and
a bottom turntable opposite to the top turntable and attached to the lift case.

4. The monitor stand system of claim 3, wherein the rotating mechanism comprises:
a worm gear mechanism coupled to the shaft; and
a first motor coupled to the worm gear mechanism.

5. The monitor stand system of claim 2, further comprising a connecting platform located between the height adjustment mechanism and the lift case, the connecting platform having a recessed structure in a center thereof, wherein the shaft of the rotating mechanism is located within and extends through the recessed structure.

6. The monitor stand system of claim 5, wherein the rotating mechanism is located beneath the recessed structure of the connecting platform.

7. The monitor stand system of claim 6, wherein the height adjustment mechanism comprises two height adjustment mechanisms, located on opposite sides of the recessed structure and beneath the connecting platform.

8. The monitor stand system of claim 1, wherein the arm assembly of the height adjustment mechanism comprises two sets of arms that connect at scissoring pivot points, creating a scissoring motion when raising and lowering the lift case.

9. The monitor stand system of claim 8, wherein the height adjustment mechanism further comprises:
base pivot points coupled to the bottom case, each fixed relative to the bottom case;
lift pivot points coupled to the lift case, each fixed relative to the lift case;
sliding assemblies on an end of an arm of the two sets of arms between the end of the arm and either the lift case or the bottom case; and
a second motor having a driving shaft coupled to the arm assembly, the second motor configured to provide a force that drives the scissoring motion.

10. The monitor stand system of claim 9, wherein the base pivot points and the lift pivot points are located on the same side of the scissoring pivot points.

11. The monitor stand system of claim 1, wherein the lift case further comprises an optical sensor electrically coupled to the controller and configured to detect and store an initial position of user's eyes as a reference; and wherein the controller is further configured to control the height adjustment mechanism to raise or lower the lift case based on a deviation between a real-time position of the user's eyes and the reference.

12. The monitor stand system of claim 2, wherein the lift case further comprises an optical sensor electrically coupled to the controller and configured to detect and store an initial position of user's eyes as a reference; and wherein the controller is further configured to control the rotating mechanism to rotate the work platform based on a deviation between a real-time position of the user's eyes and the reference.

13. The monitor stand system of claim 2, wherein the lift case further comprises an optical sensor electrically coupled to the controller and configured to detect a user in front of the lift case; and wherein the controller is further configured to deactivate a rotation movement and a lifting movement of the work platform in absence of the user, and to automatically activate the rotation movement and the lifting movement upon detecting the user.

14. The monitor stand system of claim 2, wherein the lift case further comprises an optical sensor electrically coupled to the controller and configured to detect a user in front of the lift case; and wherein the controller is configured to rotate the work platform clockwise and counterclockwise twice over a short distance when the optical sensor detects that the user has been in front of the lift case for longer than a set duration to remind the user to take a break.

15. A monitor stand system comprising:
a bottom case;
a lift case located on and movably coupled to the bottom case;
a controller configured to generate an angle adjustment signal;
a work platform located on and rotatably connected to the lift case; and
a rotating mechanism located beneath and connected to the lift case and electronically coupled to the controller, the rotating mechanism comprising a shaft extending through the lift case and connected to the work platform, configured to rotate the work platform relative to the lift case at various angles according to the angle adjustment signal.

16. The monitor stand system of claim 15, wherein the rotating mechanism further comprises:
a top turntable attached to the work platform and the shaft of the rotating mechanism; and
a bottom turntable opposite to the top turntable and attached to the lift case.

17. The monitor stand system of claim 16, wherein the rotating mechanism comprises:
a worm gear mechanism coupled to the shaft; and
a first motor coupled to the worm gear mechanism.

18. The monitor stand system of claim 15, wherein the lift case further comprises an optical sensor electrically coupled to the controller and configured to detect a user in front of the lift case; and wherein the controller is further configured to deactivate a rotation movement of the work platform in absence of the user, and to automatically activate the rotation movement upon detecting the user.

19. The monitor stand system of claim 15, wherein the lift case further comprises an optical sensor electrically coupled to the controller and configured to detect a user in front of the lift case; and wherein the controller is configured to rotate the work platform clockwise and counterclockwise twice over a short distance when the optical sensor detects that the user has been in front of the lift case for longer than a set duration to remind the user to take a break.

20. The monitor stand system of claim 15, wherein the lift case further comprises an optical sensor electrically coupled to the controller and configured to detect and store an initial position of user's eyes as a reference; and wherein the controller is further configured to control the rotating mechanism to rotate the work platform based on a deviation between a real-time position of the user's eyes and the reference.
